(19) United States
(12) Patent Application Publication
(10) Pub. No.: US 2015/0309788 A1
(43) Pub. Date: Oct. 29, 2015

(54) FUNCTION MODULE MODULARIZING METHOD IN DATA DISTRIBUTION SERVICE AND MODULARIZING APPARATUS THEREOF

(71) Applicant: Electronics and Telecommunications Research Institute, Daejeon (KR)

(72) Inventors: Hyung Kook JUN, Daejeon (KR); Kyung Il KIM, Daejeon (KR); Kyeong Tae KIM, Daejeon (KR); Yong Yeon KIM, Daejeon (KR); Je Man PARK, Gwangju-si (KR); Soo Hyung LEE, Daejeon (KR); Won Tae KIM, Asan-si (KR)

(73) Assignee: Electronics and Telecommunications Research Institute, Daejeon (KR)

(21) Appl. No.: 14/547,171

(22) Filed: Nov. 19, 2014

(30) Foreign Application Priority Data
Apr. 24, 2014 (KR) 10-2014-0049503

(51) Int. Cl. G06F 9/44; G06F 17/30

(52) U.S. Cl. CPC G06F 8/70; G06F 17/30598

(57) ABSTRACT

Disclosed is a modularizing apparatus modularizing a function module in DDS middleware, including: a DCPS module providing an interface with an application program; and a library module initializing and creating the function module, classifying the created function module for each function and storing the classified function module, and providing a function module corresponding to a request by the DCPS module to the DCPS module.

### CROSS-REFERENCE TO RELATED APPLICATIONS

This application claims priority to and the benefit of Korean Patent Application No. 10-2014-0049503 filed in the Korean Intellectual Property Office on Apr. 24, 2014, the entire contents of which are incorporated herein by reference.

### TECHNICAL FIELD

The present invention relates to a function module e modularizing method in a data distribution service and a modularizing apparatus thereof.

### BACKGROUND ART

A cyber physical system (CPS) is a system in which elements of a cyber system and actual physical system elements are closely associated and combined. In the CPS, the cyber system flexibly adapts to a change of a physical environment and reconfigures the system by analyzing a physical system to improve reliability. Various communication middleware which can be used under a CPS environment are proposed and in particular, a data distribution service (DDS) communication middleware proposed by OMG is suitable for usage under the CPS environment. A DDS is first made by the necessity of standardization of a data centered publication and subscription programming model in a distribution system. The DDS assists rapid and easy message transmission in a system in which a message is frequently transferred. The DDS aims at rapidly and easily processing data transmission among a plurality of nodes which are complexly entangled.

A DDS standard is constituted by an RTTS layer taking charge of transmitting and receiving data and processing network data, a DCPS layer providing an interface for data transmission and reception based on publication/subscription to a user, and a DLRL layer providing an object based access interface to user data. The user can arbitrarily use a DDS communication function based on the DDS standard. However, since the DDS standard as a standard for the publication/subscription based data transmission and reception does not propose a standard for addition of a new function except for the standard, when a new user function is added, the case of violating the structure of a DDS communication middleware occurs.

### SUMMARY OF THE INVENTION

The present invention has been made in an effort to provide a modularizing method and a modularizing apparatus in which a user or a developer can create/add a function module without violating a DDS middleware structure in a standard specification range.

The technical objects of the present invention are not limited to the aforementioned technical objects, and other technical objects, which are not mentioned above, will be apparent to those skilled in the art from the following description.

An exemplary embodiment of the present invention provides a modularizing apparatus modularizing a function module in DDS middleware, including: a DCPS module providing an interface with an application program; and a library module creating the function module, classifying the created function module for each function and storing the classified function module, and providing a function module corresponding to a request by the DCPS module to the DCPS module.

The library module may include: a connection module providing an interface with the DCPS module; a creation module initializing and creating the function module; a classification module classifying the created function module for each function and storing the classified function module; and a management module searching for the classification module and transferring the function module corresponding to the request by the DCPS module to the DCPS module through the connection module.

The creation module may initialize and create the function module by using function module distinguishing information, a function module creation function, and a function module setting variable.

The function module distinguishing information may include at least one of a name of the function module, a characteristic of the function module, and importance of the function module.

The function module setting variable may have any one of bool, integer, float, and string values.

The creation module may be defined as a structure including a common setting function for initializing the function module.

The function module may include at least one of an RTPS module, a QoS module, a TypeSupport module, and a UDP module.

Another exemplary embodiment of the present invention provides a modularizing method modularizing a function module in DDS middleware, including: configuring a common setting function for initializing the function module; initializing the function module by executing the common setting function; and creating the function module by using function module distinguishing information, a function module creation function, and a function module setting variable.

The method may further include classifying the created function module for each function and storing the classified function module.

The method may further include transferring a function module corresponding to a request by a DCPS module in the created function module to the DCPS module.

According to exemplary embodiments of the present invention, in a modularizing method and a modularizing apparatus, a user or a developer can create/add a function module without violating a DDS middle structure in a standard specification range.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the exemplary embodiments of the present invention. It can be easily known that the objects and advantages of the present invention can be implemented by the means and a combination thereof described in the appended claims.

### BRIEF DESCRIPTION OF THE DRAWINGS

FIG. 1 is a block diagram illustrating a modularizing apparatus according to an exemplary embodiment of the present invention.

FIG. 2 is a block diagram, in more detail, illustrating a library module of FIG. 1.

FIG. 3 is a block diagram, in more detail, illustrating a creation module of FIG. 2.

FIG. 4 illustrates variables used in a function module setting variable of FIG. 3.

FIG. 5 is a flowchart for describing a process of configuring the creation module of FIG. 2.

FIG. 6 is a flowchart for, in more detail, describing step S100 of FIG. 5.

FIG. 7 is a flowchart for, in more detail, describing step S200 of FIG. 5.

FIG. 8 illustrates codes for implementing respective steps of FIG. 7.

FIG. 9 is a flowchart illustrating a code conversion interface calling process of a common setting function defined in FIG. 6.

FIG. 10 illustrates a code for implementing respective steps of FIG. 9.

FIG. 11 is a flowchart illustrating a process in which a function module is created through the creation module of FIG. 2.

FIG. 12 is a block diagram illustrating a computing system which executes a modularizing method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the accompanying drawings. When reference numerals refer to components of each drawing, it is to be noted that although the same components are illustrated in different drawings, the same components are referred to by the same reference numerals as possible. In describing the exemplary embodiments of the present invention, when it is determined that the detailed description of the known art related to the present invention may obscure the understanding of the present invention, the detailed description thereof will be omitted.

Terms such as first, second, A, B, (a), (b), and the like may be used in describing the components of the exemplary embodiments according to the present invention. The terms are only used to distinguish a constituent element from another constituent element, but nature or an order of the constituent element is not limited by the terms. Unless otherwise defined, all terms used herein including technological or scientific terms have the same meaning as those generally understood by a person with ordinary skill in the art to which the present invention pertains. Terms which are defined in a generally used dictionary should be interpreted to have the same meaning as the meaning in the context of the related art, and are not interpreted as an ideally or excessively formal meaning unless clearly defined in the present invention.

The present invention relates to a function module modularizing method in a data distribution service (DDS) and a modularizing apparatus thereof, and more particularly, to a modularizing method and a method thereof that implement an RTPS standard layer and a user function module to a service plug-in form in a DDS to allow the RTPS layer to interwork with a DCPS layer when a user needs and modularizes a function module developed by the user to use the modularized function module in a DDS application in case of need. In the specification, ‘modularizing’ may mean an operation that allows the user to initialize and create various function which may be used in the DDS by the unit of a module.

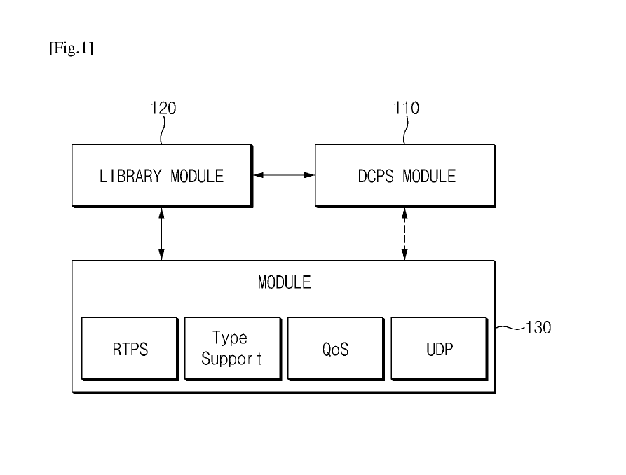

FIG. 1 is a block diagram illustrating a modularizing apparatus according to an exemplary embodiment of the present invention.

Referring to FIG. 1, the modularizing apparatus according to the exemplary embodiment of the present invention may include a DCPS module 110, a library module 120, and a module 130.

The DCPS module 110 may be defined as a DCPS layer defined in a data distribution service (DDS) standard. For example, the DCPS module 110 is an interface having a data publishing/subscribing function provided to an application program and the application program may publish/subscribe desired data without recognizing a counterpart which will exchange data through the DCPS module 110. The DCPS module 110 may provide an API in a read( )write( )mode to provide a data exchange function between application programs in the read/write mode.

The library module 120 may manage a function module (e.g., service plug-in) which may be used in a DDS. For example, the library module 120 may modularize the function module. That is, the library module 120 may initialize and create the function module, and classify the created function module for each function and store the classified function module. The library module 120 may search for a function module corresponding to a request by the DCPS module 110 and provide the searched function module to the DCPS module 110. The function module may include, for example, an RTPS module, a QoS module, a TypeSupport module, a UDP socket management module, and the like.

The module 130 may be defined as a set of the created function modules. A DDS user may dynamically load a desired function module through the DCPS module 110 and the library module 120.

That is, in the present invention, the library module 120 may provide all functions so that the function module created in the DDS is initialized, created, classified, and searched to be used in the DCPS module 110.

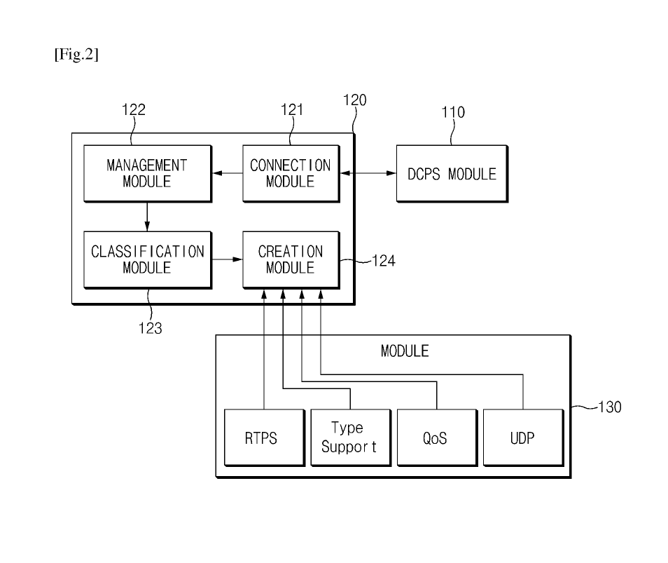

FIG. 2 is a block diagram, in more detail, illustrating a library module of FIG. 1.

In detail, FIG. 2 illustrates an overall structure including function modules managed by the library module 120.

Referring to FIG. 2, a function to initialize and create a standardized data structure and a standardized function module is required to create and use the function module in the DDS and the library module 120 may perform such a function.

The library module 120 may include a connection module 121, a management module 122, a storage module 123, and a creation module 124. The connection module 121, the management module 122, the storage module 123, and the creation module 124 may be implemented as a structure.

The library module 120 as a highest structure for interlocking with the DCPS module 110 may use the function module in the DCPS module 110 through the connection module 121. For example, the connection module 121 may be defined as DomainFactory depending on the DDS standard.

In order for a developer or a user of DDS middleware to use the function module by using the DCPS module 110, the connection module 121 may provide domain participant information of the DCPS module 110 to use the function module and reference information regarding the management module 121 that manages the function module. The domain participant information may mean information used in the DCPS module 110 in order to provide a correlation with the DCPS module 110 using the DDS middleware. That is, the connection module 121 is a start point for a DDS application program to use the DDS middleware and may be used as an entry point for using the function module in the DCPS module 110.

The management module 122 may be defined as a highest structure for managing the function module. The management module 122 may provide the reference information regarding the storage module 123 in order to store and manage all function modules created in the DDS middleware. For example, the management module 122 may include reference information regarding the connection module 121 and reference information regarding the storage module 123. The reference information regarding the connection module 121 may mean information on a reference structure of the DomainFactory. The reference information regarding the storage module 123 may mean information on a classification structure that classifies the function module. In one aspect, it may be appreciated that the management module 122 provides a management start point for the function module used in the DDS.

The classification module 123 may be defined as a structure that classifies the function module as a unique function type. The classification module 123 as a structure that classifies the function module according to a characteristic (e.g., a function) of each module may provide the reference information regarding the creation module 124, module classification type information, and a module initialization setting flag. The reference information regarding the creation module 124 may mean reference information on a function module initialization and creation structure. The module classification type information may mean type information used to classify the function module. The module initialization setting flag may mean information indicating whether initialization and creation of the function module are completed.

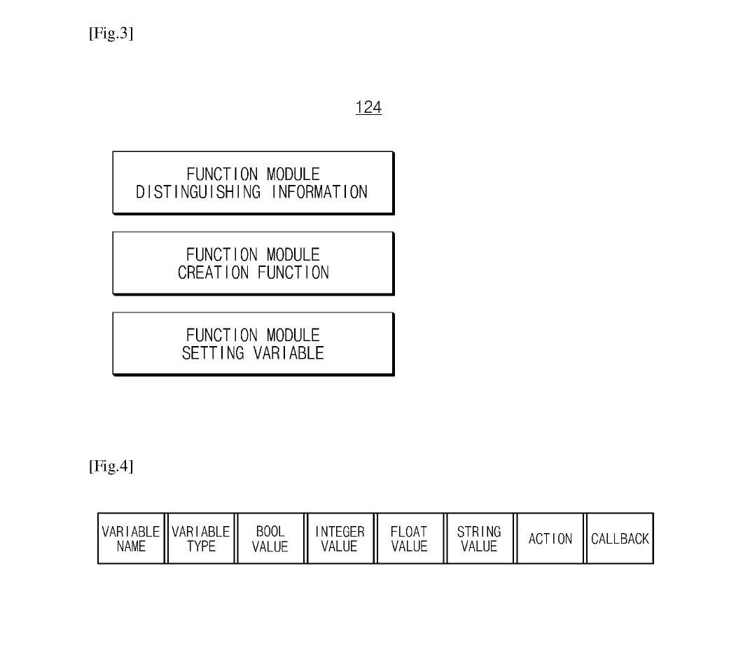

The creation module 124 may be defined as a structure that performs the initialization for creating the function module and creates the function module by using setting information. The creation module 124 will be described in more detail with reference to FIG. 3 below.

FIG. 3 is a block diagram, in more detail, illustrating a creation module of FIG. 2.

Referring to FIG. 3, the creation module 124 stores the initialization information for creating the function module, and the information on the function module stored in the creation module 124 may include function module distinguishing information for identifying the function module, a function module creation function for creating the function module, and a function module setting variable storing a setting value to be set in the function module to be created.

The function module distinguishing information may include a function module name, a function module characteristic, and function module importance, and the like for identifying the function module. The function module creation function may include a creator function for creating the function module and a delete function for deleting the function module. For example, when the function is to be created, a desired function module may be created by registering the creator function in the function module creation function. When the function module is to be deleted, the function module may be deleted by registering the delete function in the function module creation function.

The function module setting variable may mean a variable set in the function module when the function module is created by executing the function module creation function. A type of a variable which is supportable in the function module setting variable may include all data types including a bool, an integer, a character, and a string.

FIG. 4 illustrates variables used in a function module setting variable of FIG. 3.

Referring to FIG. 4, the function module setting variable may be constituted by a variable name for distinguishing the variable, type information for distinguishing the type of a variable, a bool value, an integer value, a float value, and a string value which are actual values depending on the type of the variable, an action for storing a function called when the variable is used, and a callback called when using the variable is ended.

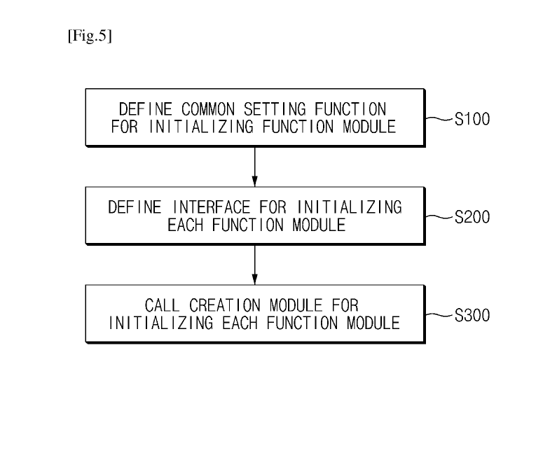

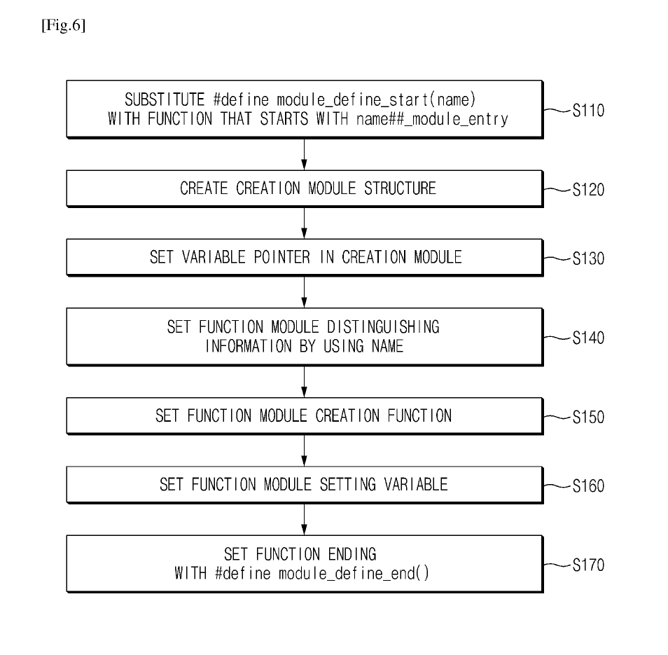

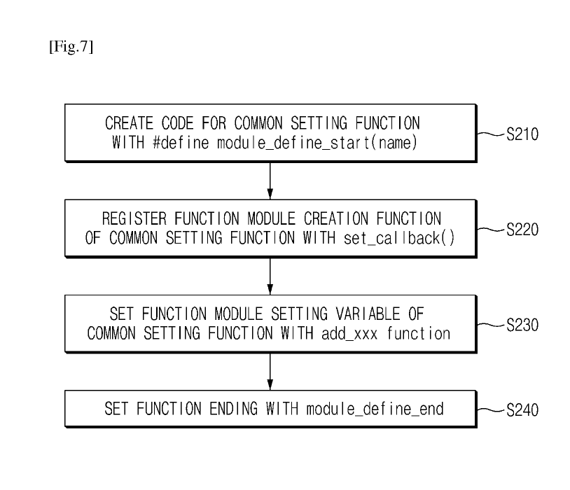

FIG. 5 is a flowchart for describing a process of configuring the creation module of FIG. 2. FIG. 6 is a flowchart for, in more detail, describing step S100 of FIG. 5. FIG. 7 is a flowchart for, in more detail, describing step S200 of FIG. 5.

First, referring to FIG. 5, a process of configuring the creation module 124 for initializing the function module in order to create the function module will be described.

The process of configuring the creation module 124 is constituted by configuring a common setting function in order to provide a standardized function module initializing process (S100), defining a creation module setting interface that provides a setting code by changing the common setting function to be suitable for initializing each function module (S200), and calling the creation module 124 in order to initialize the creation module 124 by initializing each function module (S300).

The creation module 124 as a structure including creation and setting information regarding the function module used in the DDS may create the function module by setting the function module distinguishing information, the function module creation function, and the function module setting variable included in the creation module 124.

Referring to FIG. 6, step S100 described with reference to FIG. 5 will be described in more detail. odule_define_start(name) is used in order to provide the common setting function for initializing the creation module. Name in module_define_start(name) is a name of each function module and may be appreciated as a name of the function module to be initialized. Define_module_start(name) may be defined as a function that starts with name##_module_entry (S110). Therefore, each function module may create an initialization function corresponding to each function module with a name input in the name based on the common setting function.

When the name may be changed to a function name corresponding to each name##module_entry (S120) and a variable pointer is set in the creation module (S130).

The function module distinguishing information is set by using name information (S140), the function module creation function is set (S150), and the function module setting variable is set (S150).

The common setting function is ended through #define module_define_end( ) (S160). The common setting function is configured through steps S110 to S160 described above.

Referring to FIG. 7, step S200 described with reference to FIG. 5 will be described in more detail.

FIG. 7 may be appreciated as a step of converting a function and creating a setting code for setting the creation module 124 to corresponding to the name of each function module based on the common setting function defined in FIG. 6.

In step S210, module_define_start is converted into name##_module_entry to create the setting code by converting the common setting function to be suitable for each function module and step S210 may correspond to step S110 of FIG. 6.

Step S220 as a step of registering the function module creation function in the creation module 124 based on the setting code converted to be suitable for the function module may correspond to step S150 of FIG. 6.

Step S230 as a step of setting the function module variable (e.g., a variable for initialization) in the creation module 124 may correspond to step S160 of FIG. 6.

Step S240 as a step of ending an initialization step for each function module as Module_define_end( )may correspond to step S170 of FIG. 6.

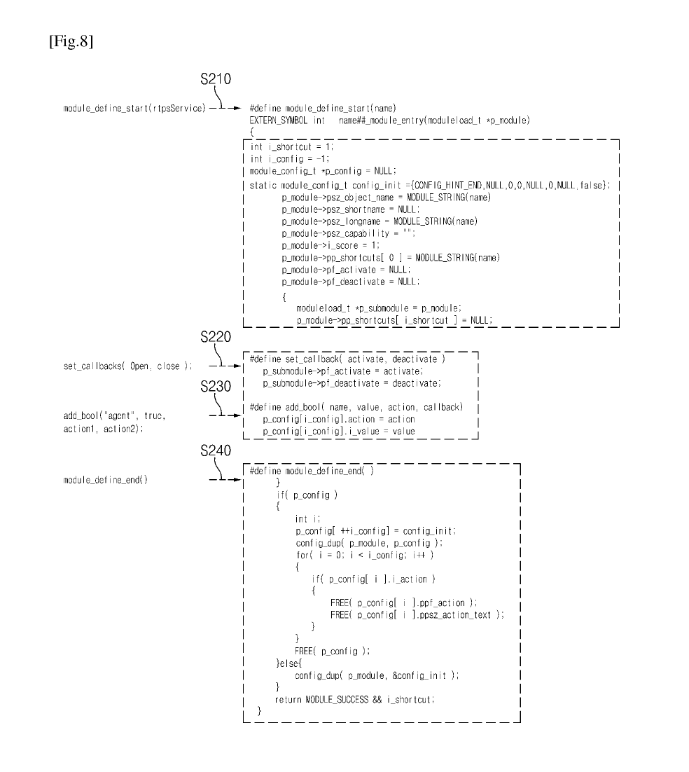

FIG. 8 illustrates codes for implementing respective steps of FIG. 7.

Referring to FIG. 8, a mapping structure of the common setting function used for initializing each function module and an interface used to convert and create the setting code using the common setting function in each function module is exemplified in FIGS. 6 and 7.

A right code (that is, a code below #define module_define_start(name)) of FIG. 8 represents the common setting function described n FIG. 7 and a left code (that is, a code below module_define_start(rtpsService)) of FIG. 8 represents an example of an interface call that creates the setting code by converting the common setting function to be suitable for each user function module with the function module described in FIG. 7.

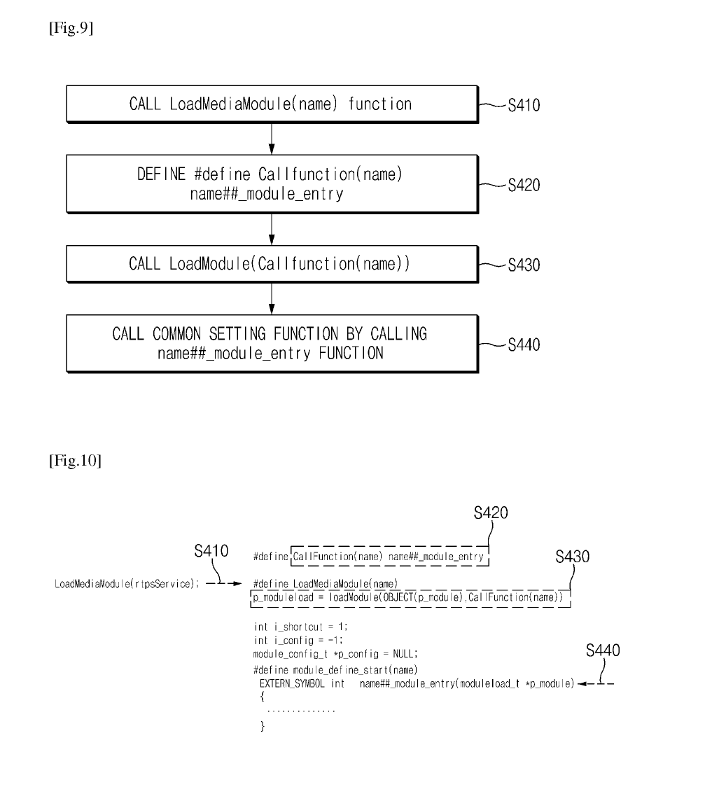

FIG. 9 is a flowchart illustrating a setting code conversion interface calling step of the common setting function defined in FIG. 6.

In detail, FIG. 9 illustrates a step of executing the initialization of each function module based on the common setting function defined in FIG. 6 and the setting code acquired through the setting code conversion interface calling step of the common setting function for initializing each function module defined in FIG. 7.

Each function module executes the common setting function for the initialization created in FIGS. 6 and 7 for modularization. In the step of executing the common setting function for the initialization, a LoadMediaModule(name) function is called to initialize the function module corresponding to the name (S410). In this case, the call corresponding to the name is changed to name##_module_entry by define (S420) and a value of the define is transferred to a factor of a loadModule function to call name##_module_entry defined by #define module_start_define of S110 of FIG. 6 (S430).

In step S440, the function module distinguishing information, the function module creation function, and the function module variable setting step for the creation module (124) structure for initializing each function module are performed.

That is, the steps of FIGS. 6, 7, and 9 are steps of initializing the function module in order to create the function module, and it may be appreciated that FIG. 6 illustrates a step of creating the common setting function for initializing the function module, FIG. 7 illustrates a step of converting the common setting function for initializing the function module to be suitable for each function module, and FIG. 9 illustrates a step of initializing each function module.

FIG. 10 illustrates codes for implementing respective steps of FIG. 9.

In detail, FIG. 9 illustrates an example of implementing each process of FIG. 9 and referring to FIG. 10, when a LoadMediaModule(rtpsService) function is executed, a loadModule( ) function is executed and in this case, the factor CallFunction(name) is converted into rtpsService##_module_entry, and the LoadModule( ) function is rtpsService##_module_entry-executed by receiving rtpsService##_module_entry as the factor to call S110 of FIG. 6, and as a result, the function module is initialized.

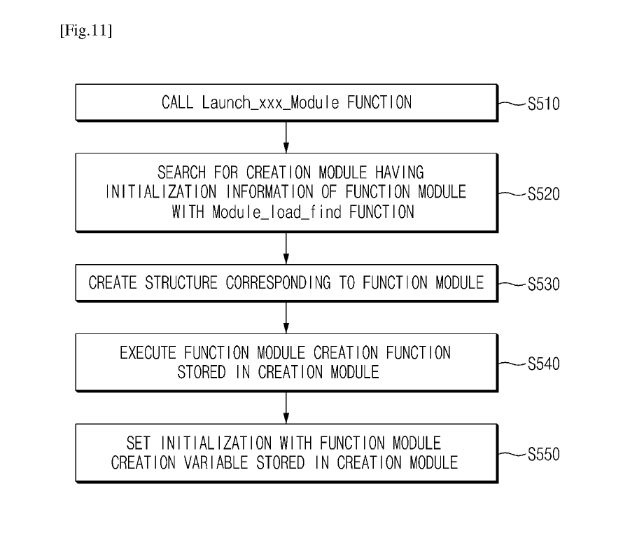

FIG. 11 is a flowchart illustrating a process in which a function module is created through the creation module of FIG. 2.

FIG. 11 illustrates a step of creating the function module by using the function module creation function and the function module setting variable set in the creation module 124. The function module may be created by calling the creator function set in the function module creation function.

When the common setting function to create the function module in the creation module is configured through the steps illustrated in FIGS. 6, 7, and 9, a Launch_xxx_Module function is called to start creating the function module (S510). The Launch_xxx_Module function calls a Module_load_find function and the Module_load_find function searches for initialization information of the function module to be created (S520). In this case, as search information, information set in the function module distinguishing information described in FIG. 3 is used. When the initialization information is searched, a structure corresponding to the function module is created (S530) and the function module creation function stored in the creation module 124 is executed by using the created function module as the factor (S540). In this case, the function module may initialize the function module by using the function module setting variable information stored in the creation module 124 (S550). The function module creation function stored in the creation module 124 operates like the creator function for creating the function module, such as initialization for the structure, function setting, thread creation, or the like by receiving the structure for the function module as the factor.

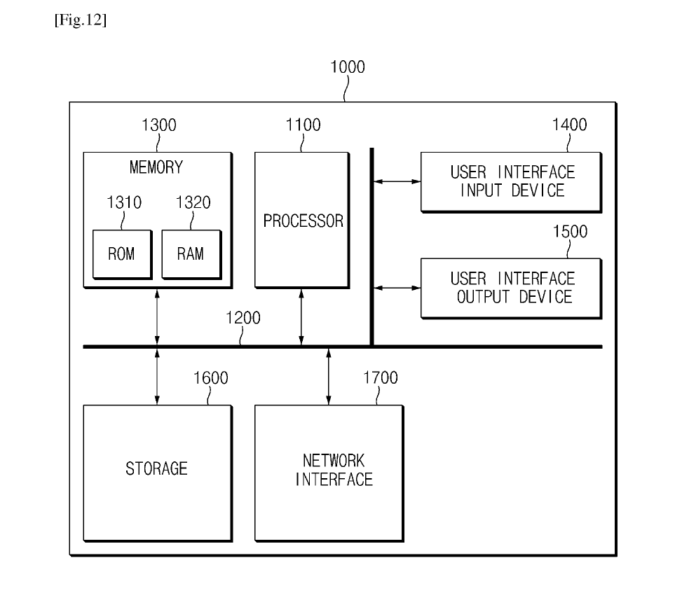

FIG. 12 is a block diagram illustrating a computing system that executes a modularizing method according to an exemplary embodiment of the present invention.

Referring to FIG. 12, the computing system 1000 may include one or more processors 1100 connected through a bus 1200, a memory 1300, a user interface input device 1400, a user interface output device 1500, a storage 1600, and a network interface 1700.

The processors 1100 may be a central processing unit (CPU) or a semiconductor device that processes commands stored in the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM memory, a flash memory, a ROM memory, an EPROM memory, an EEPROM memory, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in a user terminal. As yet another method, the processor and the storage medium may reside in the user terminal as individual components.

Various exemplary embodiments of the present invention have been just exemplarily described, and various changes and modifications may be made by those skilled in the art to which the present invention pertains without departing from the scope and spirit of the present invention. Accordingly, the embodiments disclosed herein are intended not to limit but to describe the technical spirit of the present invention, and the scope of the technical spirit of the present invention is not limited to the embodiments. The scope of the present invention may be interpreted by the appended claims and all the technical spirit in the equivalent range thereto are intended to be embraced by the claims of the present invention.

What is claimed is:

1. A modularizing apparatus modularizing a function module in DDS middleware, the apparatus comprising:
a DCPS module providing an interface with an application program; and
a library module initializing and creating the function module, classifying the created function module for each function and storing the classified function module, and providing a function module corresponding to a request by the DCPS module to the DCPS module.

2. The apparatus of claim 1, wherein the library module includes:
a connection module providing an interface with the DCPS module;
a creation module initializing and creating the function module;
a classification module classifying the created function module for each function and storing the classified function module; and
a management module searching for the classification module and transferring the function module corresponding to the request by the DCPS module to the DCPS module through the connection module.

3. The apparatus of claim 2, wherein the creation module initializes and creates the function module by using function module distinguishing information, a function module creation function, and a function module setting variable.

4. The apparatus of claim 3, wherein the function module distinguishing information includes at least one of a name of the function module, a characteristic of the function module, and importance of the function module.

5. The apparatus of claim 3, wherein the function module setting variable has any one of bool, integer, float, and string values.

6. The apparatus of claim 2, wherein the creation module is defined as a structure including a common setting function for initializing the function module.

7. The apparatus of claim 1, wherein the function module includes at least one of an RTPS module, a QoS module, a TypeSupport module, and a UDP module.

8. A modularizing method modularizing a function module in DDS middleware, the method comprising:
configuring a common setting function for initializing the function module;
initializing the function module by executing the common setting function; and
creating the function module by using function module distinguishing information, a function module creation function, and a function module setting variable.

9. The apparatus of claim 8, further comprising:
classifying the created function module for each function and storing the classified function module.

10. The apparatus of claim 9, further comprising:
transferring a function module corresponding to a request by a DCPS module in the created function module to the DCPS module.
